(19) United States
(12) Patent Application Publication
(10) Pub. No.: US 2015/0020404 A1
(43) Pub. Date: Jan. 22, 2015

(54) MULTIFUNCTIONAL MICROWAVE OVEN

(71) Applicant: Tae Hyung KIM, Busan (KR)

(72) Inventor: Tae Hyung KIM, Busan (KR)

(21) Appl. No.: 14/332,623

(22) Filed: Jul. 16, 2014

(30) Foreign Application Priority Data
Jul. 19, 2013 (KR) 20-2013-0006022

(51) Int. Cl. F26B 3/28; F26B 23/04; F26B 21/00

(52) U.S. Cl. CPC F26B 3/283; F26B 21/004; F26B 23/04
USPC 34/265

(57) ABSTRACT

A multifunctional microwave oven includes a body having a warm air accommodation space formed in an upper portion of the body, a warm air supply portion supplying warm air to the warm air accommodation space, an electromagnetic wave shielding member provided under the warm air accommodation space, a food drying tray placed on the body, and a cover covering the food drying tray. The multifunctional microwave oven may always dry food by generating warm air by using the warm air supply portion and allowing the warm air gathered in the warm air accommodation space to flow upwardly, regardless of whether or not the multifunctional microwave oven is used to heat food.

### RELATED APPLICATIONS

This application claims the benefit of Korean Patent Application No. 20-2013-0006022, filed on Jul. 19, 2013, in the Korean Intellectual Property Office, the disclosure of which is incorporated herein in its entirety by reference.

### BACKGROUND

1. Field

One or more embodiments of the present invention relate to a multifunctional microwave oven capable of both heating and drying food.

2. Description of the Related Art

Microwave ovens are tools for heating food by using microwaves. Food dryers are tools for drying food by using warm air. A user may need to buy both the microwave oven and the food dryer. When both the microwave oven and the food dryer are separately installed in a kitchen, a space in the kitchen relatively decreases.

### SUMMARY

One or more embodiments of the present invention include a multifunctional microwave oven capable of both heating and drying food.

Additional aspects will be set forth in part in the description which follows and, in part, will be apparent from the description, or may be learned by practice of the presented embodiments.

According to one or more embodiments of the present invention, a multifunctional microwave oven includes a body having a warm air accommodation space formed in an upper portion of the body, a warm air supply portion supplying warm air to the warm air accommodation space, an electromagnetic wave shielding member provided under the warm air accommodation space, a food drying tray placed on the body, and a cover covering the food drying tray, in which the cover covers the warm air accommodation space, at least two food drying trays are provided, the warm air supply portion comprises a heat wire, a blower fan, and a heater portion accommodating the heat wire and the blower fan in the heater portion and having a warm air exhaust hole formed in a lateral side of the heater portion and an air intake hole formed in an upper surface of the heater portion, the heat wire is fixed to face the warm air exhaust hole in the heater portion, the blower fan is fixed to blow wind to the heat wire, and the heater portion is provided on a bottom surface of the warm air accommodation space.

An air filter may be provided at a center portion of the cover, and a center through-hole may be formed at a center portion of the food drying tray.

### BRIEF DESCRIPTION OF THE DRAWINGS

These and/or other aspects will become apparent and more readily appreciated from the following description of the embodiment, taken in conjunction with the accompanying drawing in which:

FIG. 1 is a perspective view of a multifunctional microwave oven according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list

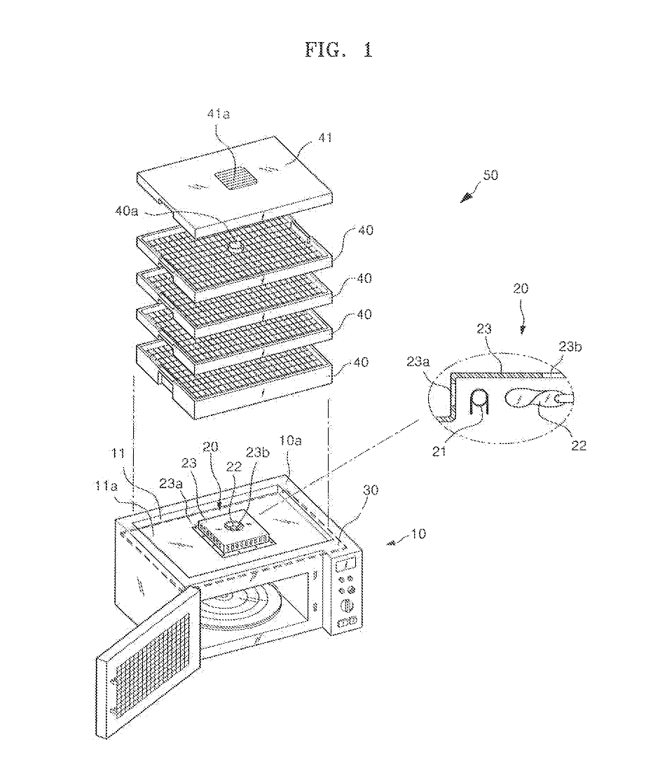

FIG. 1 is a perspective view of a multifunctional microwave oven 50 according to an embodiment of the present invention.

Referring to FIG. 1, the multifunctional microwave oven 50 according to the present embodiment may include a body 10 having a warm air accommodation space 11 formed in an upper portion thereof, a warm air supply portion 20 supplying warm air to the warm air accommodation space 11, an electromagnetic wave shielding member 30 provided under the warm air accommodation space 11, a food drying tray 40 placed on the body 10, and a cover 41 covering the food drying tray 40. The cover 41 covering the food drying tray 40 may also cover the warm air accommodation space 11. At least two food drying trays 40 are provided. The warm air supply portion 20 may include a heat wire 21, a blower fan 22, and a heater portion 23 accommodating the heat wire 21 and the blower fan 22 therein and having a warm air exhaust hole 23a formed in a lateral side thereof and an air intake hole 23b formed in an upper surface thereof. The heat wire 21 is fixed to face the warm air exhaust hole 23a in the heater portion 23. The blower fan 22 is fixed to blow wind to the heat wire 21. The heater portion 23 is provided on a bottom surface 11a of the warm air accommodation space 11.

Also, an air filter 41a is provided at a center portion of the cover 41, and a center through-hole 40a is formed at a center portion of the food drying tray 40.

In the operation and effects of the multifunctional microwave oven 50 according to the present embodiment, the multifunctional microwave oven 50 may always dry food by generating warm air by using the warm air supply portion 20 and allowing the warm air gathered in the warm air accommodation space 11 to flow upwardly, regardless of whether the multifunctional microwave oven 50 is used to heat food. Accordingly, since a separate food dryer does not need to be bought, costs may be saved. Furthermore, a relatively large space may be secured in a kitchen, compared to a case of placing a microwave oven and a food dryer separately in the kitchen.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A multifunctional microwave oven comprising:
a body having a warm air accommodation space formed in an upper portion of the body;
a warm air supply portion supplying warm air to the warm air accommodation space;
an electromagnetic wave shielding member provided under the warm air accommodation space;
a food drying tray placed on the body; and
a cover covering the food drying tray,
wherein the cover covers the warm air accommodation space, at least two food drying trays are provided, the warm air supply portion comprises a heat wire, a blower fan, and a heater portion accommodating the heat wire and the blower fan in the heater portion and having a warm air exhaust hole formed in a lateral side of the heater portion and an air intake hole formed in an upper surface of the heater portion, the heat wire is fixed to face the warm air exhaust hole in the heater portion, the blower fan is fixed to blow wind to the heat wire, and the heater portion is provided on a bottom surface of the warm air accommodation space.
